(19) United States
(12) Patent Application Publication
(10) Pub. No.: US 2005/0212159 A1
(43) Pub. Date: Sep. 29, 2005

(54) Process for manufacturing powder coating compositions introducing hard to incorporate additives and/or providing dynamic color control

(76) Inventors: George E. Richards, Berea, OH (US); Joseph M. Ferencz, Litchfield, OH (US); Vincent A. Gaspar, Columbia Station, OH (US); Jaroslav O. Hruszkewycz, Parma, OH (US); Angela K. Staufer, Broadview Heights, OH (US)

Correspondence Address: PPG INDUSTRIES, INC.;Intellectual Property Department, One PPG Place, Pittsburgh, PA, 15272, US

(21) Appl. No.: 10/809,764

(22) Filed: Mar. 25, 2004

(51) Int. Cl. B29C 47/00; B29C 47/92

(52) U.S. Cl. 264/40.7; 264/211; 264/78

(57) ABSTRACT

An extrusion process for manufacturing thermosetting powder coating compositions is disclosed. A base material is fed to an extruder body such as from a pre-mix hopper; in one embodiment, hard to incorporate additives, such as pigments, are added to the base material after they exit from the pre-mix hopper and before they exit from the extruder body. In another embodiment, hard to incorporate additives in a dried form are added with the base material. The combined base material and hard to incorporate additives are mixed through at least a portion of the extruder body to form a homogeneous thermosetting powder coating composition. The output of the extruder body may be monitored for composition accuracy, wherein the amount of hard to incorporate additives added is dynamically adjusted based upon the monitored output. The process may be repeated for thermosetting powder coating compositions having distinct hard to incorporate additives utilizing a common base material in the pre-mix hopper. Use of one or more hyperdispersed pigments in the formation of a powder coating is also disclosed.

### FIELD OF THE INVENTION

The present invention relates to the field of manufacturing powder coating compositions, and in particular to an extrusion process for forming thermosetting powder coating compositions that can introduce hard to incorporate additives and/or that can provide dynamic color control.

### BACKGROUND OF THE INVENTION

Powder coating compositions are well known in the industry and have been prepared by various methods. The use of powder coatings has grown dramatically primarily due to their environmental advantages over liquid coatings, e.g. solvent based coatings. Specifically, powder coatings do not contain volatile organic solvents that evaporate during application or curing; omitting solvent results in considerable environmental and costs savings. For example, conditioned air from powder paint booths may be recycled rather than exhausted because it does not contain solvent vapor. Further, powder coating overspray is easily captured and recycled without the use of a water-wash system, eliminating environmentally difficult paint sludge from booth wash water.

Thermosetting coating powders are typically made by first blending or “dry mixing” the resin(s) and curing agent(s) with other dry ingredients, such as colorants, catalysts, flow control additives, fillers, or UV stabilizers in a batch mixer, also called a pre-mix hopper. This “pre-mix” batch is then fed to and melt compounded in a single- or twin-screw extruder body. In the extruder body, the resin melts, the ingredients are compacted, and the constituents are completely dispersed in the molten resin. A typical extruder body will have heat applied to the extruder body along the entire length thereof (except perhaps at the intake spot) to maintain the materials at an elevated temperature and facilitate the melt mixing process. The temperature applied along the length of the extruder is typically selected above the melt temperature of the resin but below the temperature that would cause significant crosslinking to occur. It is desired that minimal reaction occur between the resin(s) and curing agent(s) in the extruder. As the melt mix exits the extruder body as “extrudate”, it is cooled rapidly on a cooled drum and then passed to a cooled belt. The cooled extrudate is broken into granules. The friable granules are then ground in a hammer mill, or the like, to a fine particle size that may be further processed, such as by being screened in a classifier, before packaging.

The conventional powder-forming process can result in significant wasted product if the formulation is not precise. For example, if the extrudate is slightly off color as it exits the extruder body, as measured by an appropriate sensor (e.g. an electrical resistance sensor, or optical measurement sensor), then the amount of pigment added to the pre-mix hopper will be adjusted accordingly in the next batch; this is known as “batch control”. Adjustment cannot be made until the next batch. The product loss is effectively equal to the entire load of material in the pre-mix hopper. Additional waste can be generated if pigment and/or other hard to incorporate components of the powder do not adequately blend to form a homogeneous material. Further, color changes and/or formulation changes from one batch to the next require extensive and time-consuming cleaning of the pre-mix hopper and the extruder body. This cleaning time is particularly relevant when generating small batches of pigmented powder coatings. Therefore, there remains a need for an extrusion method of producing pigmented powder coating compositions that disperses hard to incorporate additives, such as pigments, uniformly throughout the extrudate without detrimentally affecting the extrudate and/or which allows for dynamic control and/or more efficient clean up between runs.

### SUMMARY OF THE INVENTION

The present invention provides extrusion processes for manufacturing thermosetting powder coating compositions that maintain adequate dispersion of ingredients within the extrudate; dynamic control may also be achieved according to the present invention. The present invention may also provide enhanced color development. Rapid and efficient change out between runs of different colors and/or formulations is also an advantage of certain embodiments of the present invention. In certain embodiments, the present processes for manufacturing powder coating compositions decrease product loss due to batch control by allowing for dynamic control, and also may decrease loss due to insufficient blending of hard to incorporate additives. This is achieved by separately adding the hard to incorporate additives, as is more fully discussed below.

### BRIEF DESCRIPTION OF THE DRAWINGS

FIG. 1 is a schematic view of an extruder for use in a process according to one embodiment of the present invention; and

FIG. 2 is a schematic view of an extruder for use in a process according to one embodiment of the present invention.

### DETAILED DESCRIPTION OF THE INVENTION

The present invention is directed to a process for manufacturing thermosetting powder coating compositions comprising feeding a base material to a main extruder body from an initial position, such as from a pre-mix hopper of the extruder “Initial position” refers to the point at which base material is introduced to the extruder. “Base material” refers to one or more of the components that form the powder coating including, for example, resin(s), curing agent(s), catalyst(s), flow control additives, fillers, degassing additives and/or UV stabilizers and the like. Base material can include one or more “hard to incorporate additives” according to the present invention, but at least one hard to incorporate additive will not be added to the extruder as a base material. “Hard to incorporate additives” will be understood by those skilled in the art as additives that are not readily dispersed during the extrusion process, including pigments, flow additives, and components having a melting point higher than the melting point of the resin or average melting point of the resins, used in the base material. According to certain embodiments of the present methods, at least one hard to incorporate additive is added to the base material after the base material exits the initial position but prior to the extrudate exiting the main extruder body. The hard to incorporate additive(s) may be dispersed in a liquid diluent or in an aqueous dispersion, or may be in solid form. The combined base material and hard to incorporate additive(s) are passed and mixed through at least a portion of the extruder body to form a thermosetting powder coating composition.

In one embodiment, the hard to incorporate additive is a pigment, or a combination of pigments, that is in a “hyperdispersed” form. “Hyperdispersed pigment” as used herein refers to pigments that have been subjected to additional grinding and/or dispersion steps that result in the pigments having an average particle size of two microns or less. For example, the average pigment particle size can be 1 to 2 microns, or can be less than 1 micron. The hyperdispersed pigment can be in a variety of forms including solid or liquid. The liquid hyperdispersed pigment can be water-based and in one embodiment can contain up to about 10 weight percent of solvent. In one embodiment, the liquid hyperdispersed pigment has a solvent content of greater than 5 up to 10 weight percent. In another embodiment, the liquid hyperdispersed pigment can have greater than 10 weight percent solvent, although use of such a pigment in an extruder could be a hazard.

One method for preparing a liquid hyperdispersed pigment generally involves solubilizing a resin with an organic solvent. Any organic solvent and/or aqueous dispersions and/or solutions can be used according to the present invention, including, for example ketones, acetates, and xylene, water, and glycol ethers. Similarly, any resin can be used. For example, this resin can be the same as the resin(s) used in the base material, or can be a resin other than that used in the base material, provided such a resin is compatible with the base materials and/or is used in compatible amounts. The pigment(s) are added to the solubilized resin. Other additives can also be included, such as wetting agents, flow agents, and the like. The mixture typically undergoes a pre-mix stage, during which the materials are homogenized. The pre-mix is then processed through an appropriate mill, such as a horizontal media mill, in which the pigment is dispersed in the solubilized resin. One or more passes through the mill are typical. The resulting liquid, referred to herein as “liquid pigment dispersion”, can be added to the extruder via the injection port, as described further below.

Alternatively, the liquid pigment dispersion can be dried, such as by spray, vacuum or convection drying. The residue, referred to herein as “dried liquid pigment dispersion”, is typically crystalline. The crystals can be milled and the dried liquid pigment dispersion can then be added to the extruder with the base materials. In one embodiment of the present invention, the dried liquid pigment dispersion is prepared from a liquid dispersion having greater than 5 weight percent, such as up to about 40 weight percent, or even up to about 80 weight percent organic solvent. The dried liquid pigment dispersion can be added via the injection port or with the base material itself. Other solid forms of hyperdispersed pigments can be obtained by resin encapsulation by flushing followed by vacuum drying, heat drying and/or atomized drying, for example.

In one embodiment of the present invention, the base material travels through a portion of the main extruder body before the addition of the hard to incorporate additive(s); in another embodiment of the present invention, the hard to incorporate additive(s) are added at the initial position. In yet another embodiment, the hard to incorporate additive comprises a hyperdispersed pigment, and it is added with the base material. When the hard to incorporate additive(s) are in liquid form, they are added to the extruder at either the initial position or at a point downstream of the initial position. Particularly suitable for addition of pigments is the use of the liquid pigment dispersion, described above. When added in liquid form via injection, the liquid pigment dispersion typically contains about 10 weight percent or less organic solvent such as greater than 5 to 10 weight percent. When the hard to incorporate additive(s) are added in solid form, they are also added at either the initial position or downstream of the initial position; a dried liquid pigment dispersion prepared from a liquid pigment dispersion having greater than 5 weight percent solvent, such as up to 40 weight percent solvent or about 25 or 35 weight percent solvent, can be added with the base materials themselves. Hard to incorporate additives in liquid pigment dispersion form can be added to the extruder, for example, through a separate tube through the pre-mix hopper and into the extruder. When in dried liquid pigment dispersion form as described above, the powder can be added to the hopper in the same manner as the base material; for example, it can be pre-mixed with base material before addition to the extruder. It will be appreciated by those skilled in the art that the introduction of a liquid dispersion into a powder coating formulation can typically be problematic; use of the liquid dispersion described herein, however, avoids the problems of caking, gumming and the like typically seen when a liquid is added to a powder formulation. Use of a hyperdispersed pigment in any form, according to the present invention, facilitates the dispersion in the final coating formulation.

The present invention provides for monitoring the output of the main extruder body together with dynamically changing or adjusting, as needed, the amount of hard to incorporate additive(s) added to the extruder body. This will dynamically control the manufactured thermosetting powder coating based upon the monitored output. Further, this will minimize product loss by minimizing unsatisfactory extrudate (e.g. discolored extrudate). This is further described below.

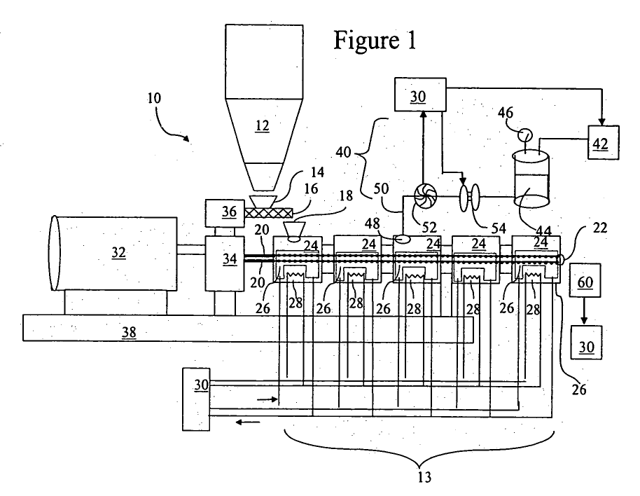

FIG. 1 is a schematic view of an extruder 10 for use in an extrusion process according to one embodiment of the present invention for manufacturing thermosetting powder coating compositions incorporating hard to incorporate additive(s); the extruder according to one embodiment of the present invention may also provide dynamic control and/or rapid change between runs, as will be described below. The extruder 10 includes a pre-mix hopper 12, for holding and introducing the base material, and a main extruder body 13. The base material is fed from the pre-mix hopper 12 through an exit or funnel 14 that leads to a mechanical feeder 16, such as a feed screw. The feeder 16 leads to a main inlet 18 of the extruder body 13. The main inlet 18 is sometimes referred to herein as the initial position. The main extruder body 13 further includes a pair of feed screws 20 extending along the length of the main extruder body 13 from the main inlet 18 to a main outlet 22 of the main extruder body 13. The “length of the extruder” 13 is measured from the main inlet 18 to the main outlet 22 along the feed screws 20.

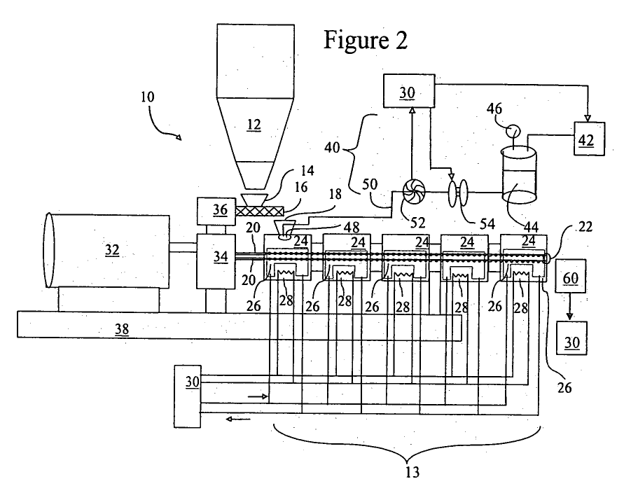

Surrounding the screws 20 are a plurality of adjacent barrels or segments 24. FIGS. 1 and 2 illustrate five (5) such segments, but any number of segments 24 may be provided as desired. Further, the individual segments 24 may be constructed of varying lengths. The five segments 24 shown in FIGS. 1 and 2 are intended to merely illustrate the broad concepts of the extruder 10 of the present invention and not be restrictive thereof. Each segment 24 includes an independent fluid jacket 26 surrounding an internal mixing chamber and a heating coil 28 adjacent the internal mixing chamber. The fluid jacket 26 is generally utilized for cooling the material in the mixing chamber through the use of a cooling fluid (e.g. water). The fluid jackets 26 and the heating coils 28 of each segment 24 are independently controlled through a central controller 30. With independent control of the heating and cooling of each segment 24 by the central controller 30, the segments 24 form separate “zones” or “portions” along the length of the main extruder body 13. FIGS. 1 and 2 illustrate “three” controllers 30, however, these are the same element that is repeated on the figure to avoid having overlapping confusing lines to the controller 30.

The extruder 10 further includes an additive injector system 40 for injecting hard to incorporate additives into the base material downstream of the exit or funnel 14 of the pre-mix hopper 12 before the main outlet 22 of the main extruder body 13. The system 40 includes a pressure source 42, such as an air pressure source, coupled to a pressure vessel 44 which holds the additives. A pressure gauge 46 with high pressure bypass (not shown) may be coupled to the pressure vessel 44. The pressure vessel 44 is coupled to an injection port 48 on the extruder body 13 through a feed line 50. The feed line 50 may include a flow meter 52 and control valve structure 54. The pressure source 42 and control valve 54 may be controlled by the central controller 30 as will be discussed.

The extruder 10 further includes a monitor or sensor 60 at the main outlet 22 of the extruder body 13. The monitor 60 and the flow meter 52 are coupled to the controller 30 to provide feedback on a relevant quality (e.g. color) and additive flow rate for dynamic control thereof. For example the electrical resistance of the extrudate may be indicative of a characteristic of the extrudate (e.g. color) and the monitor 60 will provide a real time feedback of this characteristic during processing of a batch. If the measured parameter is out of predetermined set points for the parameter, the controller 30 can dynamically adjust (i.e. during the processing of the batch) the flow rate (which is measured by the flow meter 52) through control of the control valve structure 54. The monitor 60 can then be used to check how the dynamic adjustment corrected the measured parameter by rechecking the extrudate after a time delay sufficient for the extrudate exiting the outlet 22 to have received the adjusted flow rate of the hard to incorporate additive. For example, a given color for a batch will have a predetermined flow rate of the desired pigment as a starting point. This predetermined starting flow rate will simply be based upon the calculated dispersion of pigment in the projected extrudate and the known flow rate of the extruder. If the color of the extrudate is incorrect as determined by the monitor 60, then the predetermined flow rate of pigment is also incorrect; the monitor 60 will measure the relevant parameter (e.g. electrical resistance) of the initial extrudate, the controller 30 will calculate an appropriate adjustment for the flow rate and dynamically change the flow rate. Thus, while the leading portion of the extrudate of a given batch is lost due to incorrect pigment addition, the remainder of the batch should have the proper color. Because the color can be constantly monitored, it can be adjusted as needed. Additional monitors 60 can be added to check any desired parameter as may be known in the art.

FIG. 2 is a schematic view of an extruder 10 for use in the process according to another embodiment of the present invention. The extruder 10 of FIG. 2 is substantially identical to the extruder of FIG. 1 except that the injection port 48 is positioned at the main inlet 18 of the extruder body 13.

The process as described above may be repeated for different thermosetting powder coatings. “Different thermosetting powder coatings” refers to two or more powder coatings that have different formulations as compared to each other. For example, “different” formulations can have different hard to incorporate additives, or different amounts of such additives, but the different thermosetting powder coatings will utilize a common base material in the pre-mix hopper of the extruder. As will be appreciated by those skilled in the art, the cleaning of the pre-mix hopper and the extruder are very time intensive. Use of the same base material for several batches eliminates the need to clean the pre-mix hopper between batches. It is only the extruder body 13 and the additive injector 40 that needs to be cleaned between distinct runs, e.g. runs of different color and/or formulation. Thus, the present invention provides a significant time savings when manufacturing small batches of pigmented powder coatings. “Small batch” or “small batches” refers to a batch of 1000 pounds or less.

As noted above, the base material may travel through a portion of the extruder body 13 before the addition of the hard to incorporate additive(s), or the hard to incorporate additive(s) may be added between the exit 14 of the pre-mix hopper 12 of the extruder 10 and the beginning or main inlet 18 of a main extruder body 13 of the extruder 10. In certain embodiments as described above, the solid hard to incorporate additive(s) may be added to the pre-mix hopper 12 itself. Additionally, the hard to incorporate additive(s), particularly pigment(s), may be added in solid or liquid form. “Liquid form” refers, for example, to the hard to incorporate additive(s) being contained in an aqueous dispersion or liquid diluent. “Solid form” includes, for example, solid hyperdispersed pigment. In using a liquid pigment dispersion or a dried liquid pigment dispersion in the methods according to the present invention, a 15 percent or more reduction in pigment loading was found to provide equal color development as compared to the addition of conventional pigment(s) in the dry mixing step as conventionally practiced. Moreover, the method of the present invention allows for reduced pigment loadings with superior color development and dispersion. Tinting and adjusting may also be controlled at the injection port in the method of the present invention. The base material may comprise at least one resinous binder having reactive functional groups and at least one crosslinking agent having functional groups reactive with the reactive functional groups on the resinous binder, such as wherein the resinous binder is a polymer selected from at least one of acrylics, polyesters, polyurethanes, and polyepoxides. Selection of appropriate base materials and hard to incorporate additive(s) is well within the skill of one practicing in the art.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to oligomers and both homopolymers and copolymers; the prefix “poly” refers to two or more.

It will be readily apparent to those of ordinary skill in the art that various changes may be made to the present invention without departing from the spirit and scope thereof. The described embodiment is intended to be illustrative of the present invention and not restrictive thereof. The scope of the present invention is intended to be defined by the appended claims and equivalents thereto.

1. A process for manufacturing thermosetting powder coating compositions, comprising:
A) feeding a base material to an extruder from an initial position;
B) adding at least one hard to incorporate additive to the base material after the base material enters the extruder and before it exits the extruder; and
C) passing the combined base material and hard to incorporate additive(s) through at least a portion of the extruder to form a thermosetting powder coating composition.

2. The process of claim 1, further comprising the step of D) monitoring the output from the extruder and dynamically adjusting, as needed, the amount of hard to incorporate additive(s) added to the extruder in step B) to dynamically control the manufactured thermosetting powder coating based upon the monitored output.

3. The process of claim 1, wherein the base material travels through a portion of the extruder before the addition of hard to incorporate additive(s) in step B).

4. The process of claim 1, wherein the hard to incorporate additive(s) are introduced to the extruder at the initial position.

5. The process of claim 1, wherein steps A-C) are repeated for different thermosetting powder coatings, and wherein the different thermosetting powder coatings utilize a common base material.

6. The process of claim 1, wherein the hard to incorporate additive comprises pigment(s).

7. The process of claim 1, wherein the hard to incorporate additive comprises pigment(s) dispersed in a liquid pigment dispersion.

8. The process of claim 1, wherein the hard to incorporate additive comprises pigment(s) dispersed in a dried liquid pigment dispersion.

9. The process of claim 1, wherein the hard to incorporate additive comprises one or more flow additives.

10. The process of claim 1, wherein the addition of step B) is by injection.

11. The process of claim 10, wherein the injection uses:
a low pressure vessel;
a source of pressurization coupled to the pressure vessel;
a mechanism for maintaining the pressure in the pressure vessel less than 100 psi;
a flow regulator; and
an injector outlet downstream of the flow regulator.

12. The product formed by the process of claim 1.

13. A process for manufacturing thermosetting powder coating compositions, comprising:
A) feeding a base material to an extruder from an initial position;
B) adding at least one hyperdispersed pigment to the base material; and
C) passing the combined base material and hyperdispersed pigment(s) through at least a portion of the extruder to form a thermosetting powder coating composition;
wherein the hyperdispersed pigment(s) in step B) are added either separately from the base material or with the base materials, and when added with the base material, the hyperdispersed pigment(s) are in the form of a dried liquid pigment dispersion that has been formed from a liquid pigment dispersion comprising greater than 5 weight percent organic solvent.

14. The process of claim 13, further comprising the step of D) monitoring the output from the extruder and dynamically adjusting, as needed, the amount of hard to incorporate additive(s) added to the extruder in step B) to dynamically control the manufactured thermosetting powder coating based upon the monitored output.

15. The process of claim 13, wherein steps A-C) are repeated for different thermosetting powder coatings, and wherein the different thermosetting powder coatings utilize a common base material.

16. The product formed by the process of claim 13.

17. A process for dynamic color control in a thermosetting powder coating extrusion process, the color control process comprising the steps of:
A) determining an amount of hyperdispersed pigment(s) to be added to base material introduced to an extruder to form a thermosetting powder of a desired color;
B) adding the determined amount of hyperdispersed pigment(s) to the base material;
C) monitoring the output of the extruder for accuracy of the color of the thermosetting powder coating; and
D) dynamically adjusting, as necessary, the amount of pigment(s) added at step B) based upon the monitored output;
wherein the base material travels through a portion of the extruder before the addition of pigment(s) in step B), or the pigment(s) added in step B) are added to the extruder at the same location as the base material, or the pigment(s) added in step B) are added to the extruder with the base material, and when added to the extruder with the base material, the pigment(s) are in the form of a dried liquid pigment dispersion formed from a liquid dispersion comprising greater than 5 weight percent organic solvent.

18. The process of claim 17, wherein steps A-D) are repeated for different thermosetting powder coatings having different colors and/or different formulations, and wherein the different thermosetting powder coatings utilize a common base material.

19. The process of claim 17, wherein the pigment(s) are added in the form of a liquid pigment dispersion after the base material travels through a portion of the extruder or at the same location as the base material.

20. The product made by the process of claim 17.

21. The process of claim 13, wherein the addition of step B) is by injection.

22. The process of claim 21, wherein the injection uses:
a low pressure vessel;
a source of pressurization coupled to the pressure vessel;
a mechanism for maintaining the pressure in the pressure vessel less than 100 psi;
a flow regulator; and
an injector outlet downstream of the flow regulator.

23. The process of claim 17, wherein the addition of step B) is by injection.

24. The process of claim 23, wherein the injection uses:
a low pressure vessel;
a source of pressurization coupled to the pressure vessel;
a mechanism for maintaining the pressure in the pressure vessel less than 100 psi;
a flow regulator; and
an injector outlet downstream of the flow regulator.
